(19) United States
(12) Patent Application Publication
(10) Pub. No.: US 2010/0123410 A1
(43) Pub. Date: May 20, 2010

(54) Driving and Dimming Control Device for Illuminator

(76) Inventor: Chen-Cheng Tsai, Taipei County (TW)

Correspondence Address: David Shung, P.O. Box 10557, Taipei, 100, TW

(21) Appl. No.: 12/620,635

(22) Filed: Nov. 18, 2009

(30) Foreign Application Priority Data
Nov. 18, 2008 (TW) 097220590

(51) Int. Cl. H05B 37/02

(52) U.S. Cl. 315/287

(57) ABSTRACT

The driving and dimming control device for illuminator includes an AC power input end connecting to a phase dimmer, a DC power output end for connecting to a lighting load, a rectifier connecting to the AC power input end, a pulse width modulator connecting to a transformer, a voltage/current detector, a photo-coupler connecting between the voltage/current detector and pulse width modulator, and a low-voltage-input locking circuit connecting between an output terminal of the phase dimmer and pulse width modulator. The low-voltage-input locking circuit includes a locking switch and a reset switch. The signals input to the pulse width modulator are locked by the locking switch to prohibit the pulse width modulator from hiccupping. Thus the DC output power can be stabilized.

### BACKGROUND OF THE INVENTION

1. Technical Field

The invention generally relates to illuminators, particularly to dimmable drivers for illuminator.

2. Related Art

In comparison with incandescent lamps, light emitting diodes (LEDs) have absolute ascendancy. Lifetime of the LEDs can reach 100,000 hours. The LEDs also have advantages of saving energy and fast response. Thus LED lamps are gradually replacing traditional lamps.

The LED can only be driven by direct current (DC) power, so it can not directly connect with alternating current (AC) power. An AC-to-DC converter must be added between the LED and AC power.

Furthermore, making the LED lamps constantly glow can not completely satisfy requirements of users because they can not be dimmed. Conventional incandescent lamps can perform dimming control by adjusting AC power phase. But AC power phase control can not be applied to the LED lamps. To make the LED dimmable, the AC-to-DC converter must not only perform dimming control, but also output stable DC current.

### SUMMARY OF THE INVENTION

A primary object of the invention is to provide a driving and dimming control device for illuminator which can dimmably convert AC power to DC power with stable current output.

### BRIEF DESCRIPTION OF THE DRAWINGS

FIG. 1 is a schematic diagram of the invention; and

FIG. 2 is a schematic diagram of the low-voltage-input locking circuit.

### DETAILED DESCRIPTION OF THE INVENTION

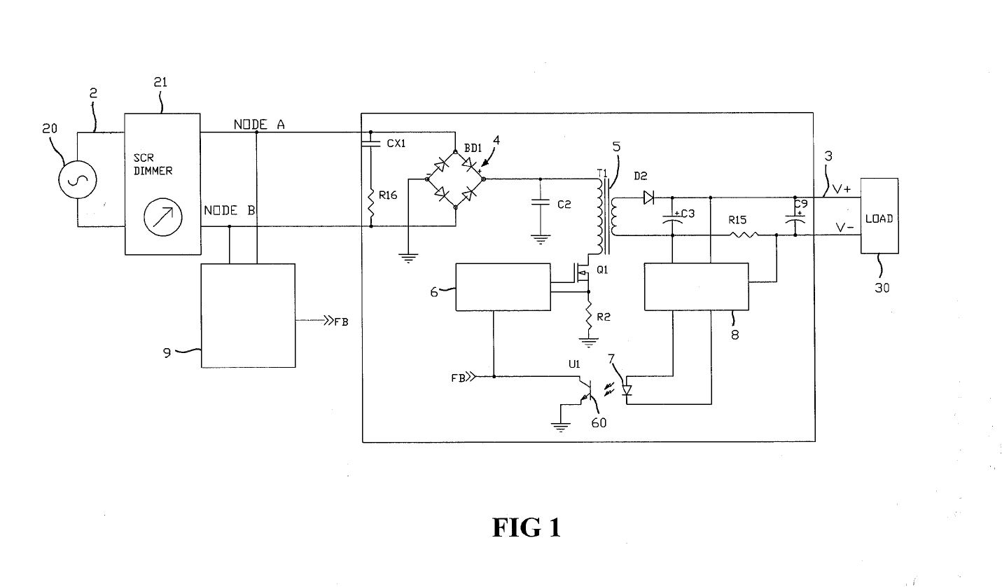

Referring to FIG. 1, the driving and dimming control device of the invention includes:

an AC power input end 2 and a DC power output end 3, wherein the AC power input end 2 is used for connecting an external AC power 20 and connects to a phase dimmer 21 such as an SCR (Silicon Controlled Rectifier) dimmer, and the DC power output end 3 is used for connecting a lighting load 30 such as an LED lamp or module;

a rectifier 4 connecting to the AC power input end 2 for converting AC power into DC power;

a transformer 5 whose primary winding connects to an output of the rectifier 4 and whose secondary winding connects to the DC power output end 3 for transforming the input voltage into a voltage required by the lighting load 30;

a pulse width modulator 5 connecting to the primary winding of the transformer 5 for outputting power signals for the lighting load 30;

a voltage/current detector 8 connecting to the secondary winding of the transformer 5 for detecting the voltage and current being input to the lighting load 30;

a photo-coupler composed of an LED 7 and a phototransistor 60, wherein the LED 7 connects to the voltage/current detector 8 and the phototransistor 60 connects to the pulse width modulator 6; and

a low-voltage-input locking circuit 9 connecting between an output of the phase dimmer 21 and pulse width modulator 6.

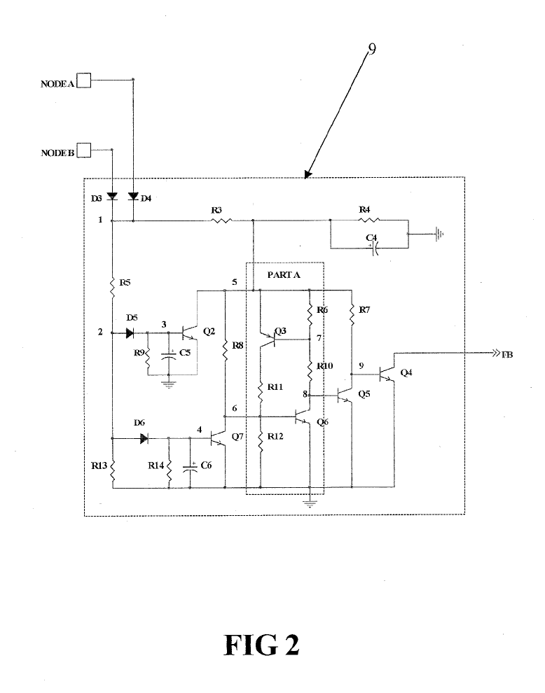

Referring to FIG. 2, the low-voltage-input locking circuit 9 includes a locking switch Q7 and a reset switch Q2. The signals input to the pulse width modulator 6 are locked by the locking switch Q7 to prohibit the pulse width modulator 6 from hiccupping when dimming.

The pulse width modulator 6, photo-coupler and voltage/current detector 8 jointly constitute an isolating feedback circuit for supplying constant current to the lighting load 30. This can prevent current from varying when voltage varies for dimming control. When the voltage/current detector 8 detects a variation of voltage or current of the lighting load 30, for example the voltage of the lighting load 30 exceeds a predetermined reference voltage, the LED 7 lights up to turn on the phototransistor 60, then the duty cycle of the pulse width modulator 6 is lowered. Therefore, the output current is stably decreased to drive the lighting load 30.

To make dimmable, the capacitor C2 between the primary winding of the transformer 5 and the output of the rectifier 4 is a metalized polypropylene (MPP) film capacitor. This kind of capacitor has very small capacitance, so it is hard to form the charge effect. It cam improve the power factor correction (PFC) value and satisfy the requirement of the phase dimmer 21.

Additionally, when the phase dimmer 21 controls the phase of AC power down to a low phase (such as smaller than 15 degree), the pulse width modulator 6 tends to hiccup because of insufficient voltage and current. This problem can be solved by the low-voltage-input locking circuit 9 connecting between an output of the phase dimmer 21 and pulse width modulator 6. Further referring to FIG. 2, the output of the phase dimmer 21 is filtered, divided and regulated to generate voltages of control nodes. The difference of the voltages can control transistors Q2 and Q7. Q7 may make circuit of part A lock to control Q5 and Q4 lock the output of the FB signal, so that the pulse width modulator 6 can be prevented from hiccupping. Q2 functions as reset to release the lock of the circuit of part A and then to restore the function of dimming.

It will be appreciated by persons skilled in the art that the above embodiment has been described by way of example only and not in any limitative sense, and that various alterations and modifications are possible without departure from the scope of the invention as defined by the appended claims.

What is claimed is:

1. A driving and dimming control device for an illuminator, comprising:
an AC power input end connecting to a phase dimmer;
a DC power output end for connecting to a lighting load;
a rectifier connecting to the AC power input end;
a transformer whose primary winding connects to an output of the rectifier and whose secondary winding connects to the DC power output end;
a pulse width modulator connecting to the transformer;
a voltage/current detector connecting to the secondary winding of the transformer;
a photo-coupler composed of an LED and a phototransistor, wherein the LED connects to the voltage/current detector and the phototransistor connects to the pulse width modulator; and
a low-voltage-input locking circuit connecting between an output of the phase dimmer and pulse width modulator;
wherein the low-voltage-input locking circuit includes a locking switch and a reset switch, signals input to the pulse width modulator are locked by the locking switch to prohibit the pulse width modulator from hiccupping.

2. The driving and dimming control device for an illuminator of claim 1, wherein the lighting load is an LED lamp.

3. The driving and dimming control device for an illuminator of claim 1, wherein the phase dimmer is a silicon controlled rectifier (SCR) dimmer.

4. The driving and dimming control device for an illuminator of claim 2, wherein the phase dimmer is a silicon controlled rectifier (SCR) dimmer.

5. The driving and dimming control device for an illuminator of claim 1, further comprising a metalized polypropylene (MPP) film capacitor between the primary winding of the transformer and the output of the rectifier.
